(19) United States
(12) Patent Application Publication
(10) Pub. No.: US 2001/0024234 A1
(43) Pub. Date: Sep. 27, 2001

(54) Digital camera

(76) Inventor: Hiroaki Kubo, Muko-Shi (JP)

Correspondence Address: SIDLEY AUSTIN BROWN & WOOD, 717 NORTH HARWOOD, SUITE 3400, DALLAS, TX, 75201, US

(21) Appl. No.: 09/817,545

(22) Filed: Mar. 26, 2001

(30) Foreign Application Priority Data
Mar. 24, 2000 (JP) 2000-88561

(51) Int. Cl. H04N 9/73

(52) U.S. Cl. 348/224; 348/296; 348/280; 348/231

(57) ABSTRACT

A digital camera is provided with a whole-frame recording mode in which image data covering an angle of view corresponding to an entire image sensor is recorded, a partial recording mode in which image data covering an angle of view corresponding to part of the image sensor is recorded, a unity-magnification display mode in which an image covering the same angle of view as image data for recording is displayed, and an enlarged display mode in which an image covering a smaller angle of view than image data for recording is displayed with enlargement. In the partial recording mode or enlarged display mode, electric charges are read out from rows of pixels located within a predetermined area on the image sensor, or from one out of a predetermined number of consecutive rows of pixels over the entire image sensor.

This application is based on Japanese Patent Application No. 2000-88561 filed on Mar. 24, 2000, the contents of which are hereby incorporated by reference.

### BACKGROUND OF THE INVENTION

1. Field of the Invention

The present invention relates to a digital camera, and particularly to a digital camera having a function of electronically enlarging an image picked up.

2. Description of the Prior Art

A digital camera picks up images repeatedly at substantially regular time intervals by means of a sensor, and, on receiving an instruction from the user to photograph, records the image data representing a picked-up image on a recording medium. Many digital cameras are equipped with a display device, such as a liquid crystal display, which is used to display, or reproduce, images that have previously been picked-up and recorded and also to display images that are currently being picked-up. Viewing a “live view”, i.e. the display of images that are currently being picked-up, the user can set the composition of a picture, confirm the focus condition, and perform other operations. Thus, the display device functions as an electronic viewfinder.

In general, the electric charges accumulated in an image-sensing device through photoelectric conversion are read out from one row of pixels after another to produce image data. The aspect ratio of the display device is identical with that of the image-sensing device. However, the display device has about 1/16 to 1/25 as many pixels as the image-sensing device, and thus the display device has about ¼ to ⅕ as many rows of pixels as the image-sensing device. For this reason, when a picked-up image is only displayed and not recorded, the electric charges accumulated in the image-sensing device are read out in a curtailed (or “thinned out”) manner, i.e. in such a way as to use only the electric charges from every fourth to fifth row of pixels.

Some digital cameras are provided with a function of producing image data for recording by using only the electric charges accumulated in a particular area of the image-sensing device in order to offer an image covering a narrow angle of view like an image taken with a telephoto lens. This function is called a “digital telephoto” function. On the other hand, some other digital cameras are provided with a function of producing image data covering a narrower angle of view than image data for recording so that an enlarged version of an image is displayed in order to make the confirmation of the focus condition easy. This function is called a “magnifier” function.

When an image for recording is picked-up by using the digital telephoto function, first the electric charges are read out from all the rows of pixels of the image-sensing device as in ordinary photographing, and then the electric charges from the unnecessary rows of pixels are discarded. For this reason, the digital telephoto function, although requiring less rows of pixels, requires about the same time to read out the electric charges as in ordinary photographing. Consequently, when an image for recording is taken by using the digital telephoto function, in principle it should be possible to start the next image pick-up sequence earlier, but in reality it is impossible to do so.

The magnifier function permits the observation of part of a taken image at a magnification of several or more times. However, the magnification here is fixed, because it is determined on the basis of the overall size of the image-sensing devices. Consequently, when the digital telephoto function is used together, an image for recording is taken with a lower magnification than when the digital telephoto function is not used. For this reason, using the digital telephoto function together with the magnifier function spoils the advantage of the latter of making the confirmation of the focus condition easy.

Moreover, when an image is picked-up that is only displayed, irrespective of whether the magnifier function is being used or not, the electric charges accumulated in the image-sensing device are read out in a manner curtailed in a predetermined ratio, and therefore an image displayed by using the magnifier function is coarse. This, too, spoils the usefulness of the magnifier function.

### SUMMARY OF THE INVENTION

An object of the present invention is to provide a digital camera in which the electric charges accumulated in the image-sensing device are read out with high efficiency when the digital telephoto function is used, and to provide a digital camera that offers the full advantage of the magnifier function of making the confirmation of the focus condition easy.

To achieve the above object, according to one aspect of the present invention, a digital camera is provided with: an image sensor having pixels arranged two-dimensionally; a controller and/or circuit for reading out the electric charges accumulated in the individual pixels of the image sensor from one row of pixels after another to produce image data of an image for display, and for producing image data of an image for recording on receiving an instruction to record; and a selector for choosing between a whole-frame recording mode in which the angle of view of the image for recording is made equal to the angle of view corresponding to substantially the entire image sensor and a partial recording mode in which the angle of view of the image for recording is made equal to the angle of view corresponding to part of the image sensor. Here, the controller and/or circuit produces the image data of the image for display by reading out the electric charges from only one row of pixels out of a plurality of consecutive rows of pixels over the entire image sensor, and, when the partial recording mode is chosen, produces the image data of the image for recording by reading out the electric charges from all the rows of pixels located within a predetermined area on the image sensor.

This digital camera operates not only in a whole-frame recording mode in which it records image data representing substantially the entire area of the image-sensor, but also in a partial recording mode in which it offers a digital telephoto function. In the partial recording mode, unless the digital camera receives an instruction to record, i.e. as long as it produces image data only for display, it reads out electric charges in a curtailed manner from the rows of pixels over the entire image sensor. On the other hand, in the partial recording mode, when the digital camera receives an instruction to record, i.e. when it produces image data for recording, it reads out electric charges from all the rows of pixels within a predetermined area on the image sensor.

By designing the digital camera not to read out electric charges from those rows of pixels which are not necessary to produce image data for recording, it is possible to reduce the time required to read out electric charges and thereby start the next image pick-up sequence promptly. When producing image data for display only, the digital camera reads out electric charges from the entire image sensor, but in a curtailed manner, i.e. from only selected rows of pixels. Thus, in this case also, it is possible to reduce the time required to read out electric charges and thereby start the next image pick-up sequence promptly. This reduces the risk of missing shutter chances, and helps shorten recording intervals in continuous photographing, in which a plurality of images are picked-up and recorded continuously.

The predetermined area on the image sensor from which to read out electric charges in the partial recording mode is fixed. This helps avoid unnecessarily complicating the configuration of the circuits used to control the image sensor and the read-out timing.

The digital camera described above may be so built that the angle of view of the image for recording in the partial recording mode is variable, and that when, in the partial recording mode, the angle of view of the image for recording is smaller than the angle of view corresponding to the predetermined area on the image sensor, the controller and/or circuit produces the image data of the image for recording by using only the electric charges read out from part of the rows of pixels located within the predetermined area on the image sensor.

That the angle of view of the image for recording in the partial recording mode is variable means that the magnification of the digital telephoto function is variable. When the magnification is high, and the angle of view of the image for recording is smaller than the angle of view corresponding to the predetermined area on the image sensor, the electric charges read out contain the electric charges from the unnecessary rows of pixels. By discarding the unnecessary electric charges and using only the necessary electric charges, it is possible to obtain appropriate image data corresponding to the magnification. Reading out unnecessary electric charges causes some inefficiency, but, since the rows of pixels from which to read out electric charges here are limited to those located within the predetermined area on the image sensor, doing so does not affect prompt starting of the next image pick-up sequence in any way, and is rather preferable to avoid complicating the configuration and processing.

Alternatively, the digital camera may be so built that the angle of view of the image for recording in the partial recording mode is variable, and that when, in the partial recording mode, the angle of view of the image for recording is greater than the angle of view corresponding to the predetermined area on the image sensor, the controller and/or circuit produces the image data of the image for recording by reading out the electric charges from all the rows of pixels over the entire image sensor and using only the electric charges read out from part of those rows of pixels.

When the magnification is low, and the angle of view of the image for recording is greater than the angle of view corresponding to the predetermined area on the image sensor, it is impossible to produce image data corresponding to the magnification from only the electric charges read out from the rows of pixels located within the predetermined area. Hence, in this case, image data is produced by reading out electric charges from all the rows of pixels over the entire image sensor. The electric charges read out contain the electric charges from the unnecessary rows of pixels. Thus, by discarding the unnecessary electric charges and using only the necessary electric charges, it is possible to obtain appropriate image data corresponding to the magnification. Reading out electric charges from all the rows of pixels of the image sensor takes a long time, but this disadvantage is more than compensated with the advantage of freely variable magnification.

According to another aspect of the present invention, a digital camera is provided with: an image sensor having pixels arranged two-dimensionally; a controller and/or circuit for reading out the electric charges accumulated in the individual pixels of the image sensor from one row of pixels after another to produce image data of an image for display, and for producing image data of an image for recording on receiving an instruction to record; a recording mode selector for choosing between a whole-frame recording mode in which the angle of view of the image for recording is made equal to the angle of view corresponding to substantially the entire image sensor and a partial recording mode in which the angle of view of the image for recording is made equal to an angle of view corresponding to part of the image sensor; and a display mode selector for choosing between a unity-magnification display mode in which the angle of view of the image for display is made equal to the angle of view of the image for recording and the image for display is displayed in a predetermined region and an enlarged display mode in which the angle of view of the image for display is made smaller than the angle of view of the image for recording and the image for display is displayed in a region substantially identical with the predetermined region used in the unity-magnification display mode. Here, the angle of view of the image for display in the enlarged display mode is set to be a predetermined angle relative to the angle of view of the image for recording both in the whole-frame recording mode and in the partial recording mode.

This digital camera operates not only in a whole-frame recording mode or in a unity-magnification display mode in which it displays the entire image for recording, but also in a partial recording mode in which it offers a digital telephoto function or in an enlarged display mode in which it offers a magnifier function. Irrespective of whether the digital camera is operating in the whole-frame recording mode or in the partial recording mode, the angle of view of the image for display that is produced in the enlarged display mode is set according to the angle of view of the image for recording. That is, the magnification of the magnifier function is set on the basis of the size of the image for recording. This permits the user to recognize whether the focus condition is appropriate for the size of the image for recording or not without fail in the enlarged display mode.

The digital camera described above may be so built that the angle of view of the image for recording in the partial recording mode is variable, and that the angle of view of the image for display in the partial recording mode is equal to or greater than a predetermined value set on the basis of the size of the image sensor.

Since the angle of view in the enlarged display mode is set to be a predetermined angle with respect to the angle of view of the image for recording, as the angle of view of the image for recording is made smaller in the partial recording mode, the portion of the image that is actually displayed becomes accordingly smaller. Displaying too small a portion of an image with enlargement makes it unclear what portion of the subject the displayed image corresponds to, and causes the boundaries between the individual pixels of the image sensor to appear conspicuously, making it impossible to confirm the focus condition. By setting the lower limit of the angle of view of the image for display produced in the enlarged display mode, it is possible to keep the size of the portion of the image that is actually displayed within a range that permits the confirmation of the focus condition without fail.

According to still another aspect of the present invention, a digital camera is provided with: an image sensor having pixels arranged two-dimensionally; a controller and/or circuit for reading out the electric charges accumulated in the individual pixels of the image sensor from one row of pixels after another to produce image data of an image for display, and for producing image data of an image for recording on receiving an instruction to record; a selector for choosing between a unity-magnification display mode in which the angle of view of the image for display is made equal to the angle of view of the image for recording and the image for display is displayed in a predetermined region and an enlarged display mode in which the angle of view of the image for display is made smaller than the angle of view of the image for recording and the image for display is displayed in a region substantially identical with the predetermined region used in the unity-magnification display mode. Here, in the unity-magnification display mode, the controller and/or circuit produces the image data of the image for display by reading out only the electric charges from one row of pixels out of a first predetermined number of consecutive rows of pixels over the entire image sensor, and, in the enlarged display mode, the controller and/or circuit produces the image data of the image for display by reading out only the electric charges from one row of pixels out of a second predetermined number, smaller than the first predetermined number, of consecutive rows of pixels within a predetermined area on the image sensor.

This digital camera operates not only in a unity-magnification display mode, but also in an enlarged display mode in which it offers a magnifier function. In the unity-magnification display mode, the digital camera produces image data of an image for display by reading out electric charges in a curtailed manner, i.e. from only selected rows of pixels, over the entire image sensor. In the enlarged display mode, the digital camera produces the image data of the image for display by reading out electric charges in a curtailed manner, i.e. from only selected rows of pixels, within the predetermined area on the image sensor. In how curtailed a manner electric charges are read out differs between in the unity-magnification display mode and in the enlarged display mode; specifically, the ratio in which an electric charge is read out for a plurality of consecutive rows of pixels is 1 (a first predetermined number) in the unity-magnification display mode and 1: (a second predetermined number) in the enlarged display mode. Here, the second predetermined number is smaller than the first predetermined number, and therefore the rows of pixels from which to read out electric charges are denser in the enlarged display mode than in the unity-magnification display mode. This prevents the image displayed in the enlarged display mode from appearing coarse and thereby makes the confirmation of the focus condition easier.

Moreover, in the enlarged display mode, electric charges are read out in a less curtailed manner, but not from all the rows of pixels located within the predetermined area on the image sensor. This reduces the time required to read out electric charges and thereby makes it possible to start the pick-up of the next image as promptly as in the unity-magnification display mode.

The digital camera described above may be so built that the first predetermined number, the second predetermined number, and the size of the predetermined area are so set that an image is displayed at substantially identical speed in the unity-magnification display mode and in the enlarged display mode. This makes it possible to display an image at speed conforming to common standards irrespective of the mode.

Alternatively, the digital camera may be so built that the first predetermined number, the second predetermined number, and the size of the predetermined area are so set that the image actually displayed is of substantially identical size in the unity-magnification display mode and in the enlarged display mode. This makes it possible to prevent change in the size of the image actually displayed as the modes are switched, although in some cases it becomes impossible to display an image at speed conforming to common standards in the enlarged display mode.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a front view of a digital camera embodying the invention;

FIG. 2 is a back view of the digital camera;

FIG. 3 is a top view of the digital camera;

FIG. 4 is a block diagram schematically showing the outline of the circuit configuration of the digital camera;

FIG. 5 is a diagram schematically showing the configuration of the image sensor of the digital camera;

FIG. 6 is a diagram showing a first example of the signal processing performed in the digital camera;

FIG. 7 is a diagram showing the pixel arrangement of the image sensor and the rows of pixels from which electric charges are read out in the first example;

FIG. 8 is a diagram schematically showing the control signals fed to the image sensor in a read operation in the first example;

FIG. 9 is a diagram showing a second example of the signal processing performed in the digital camera;

FIG. 10 is a diagram showing the rows of pixels from which electric charges are read out in the second example;

FIG. 11 is a diagram showing a third example of the signal processing performed in the digital camera;

FIG. 12 is a diagram schematically showing the control signals fed to the image sensor in a read operation in the third example;

FIG. 13 is a diagram showing a fourth example of the signal processing performed in the digital camera;

FIG. 14 is a diagram showing the relationship between the angle of view of the image sensor, the angle of view of an image for recording, and the angle of view of an image for display in the fourth example;

FIG. 15 is a diagram showing a fifth example of the signal processing performed in the digital camera;

FIG. 16 is a diagram showing the rows of pixels from which electric charges are read out in the fifth example;

FIG. 17 is a diagram showing a sixth example of the signal processing performed in the digital camera;

FIG. 18 is a diagram showing the relationship between the angle of view of the image sensor, the angle of view of an image for recording, and the angle of view of an image for display in the sixth example;

FIG. 19 is a diagram showing a seventh example of the signal processing performed in the digital camera;

FIG. 20 is a diagram showing an eighth example of the signal processing performed in the digital camera;

FIG. 21 is a diagram showing a ninth example of the signal processing performed in the digital camera; and

FIG. 22 is a diagram showing a tenth example of the signal processing performed in the digital camera.

### DESCRIPTION OF THE PREFERRED EMBODIMENTS

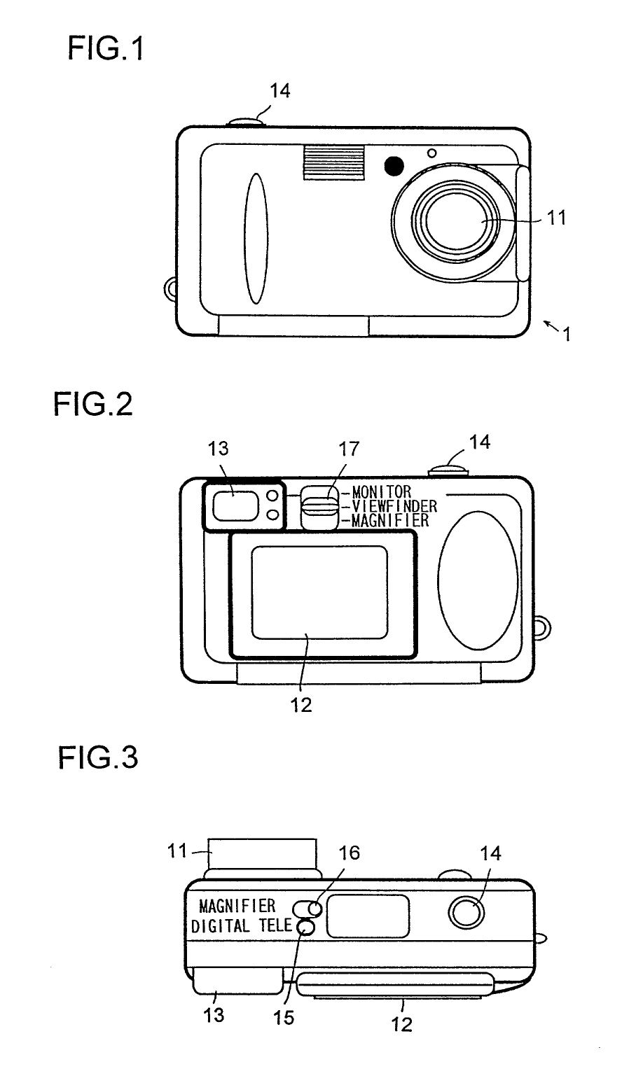

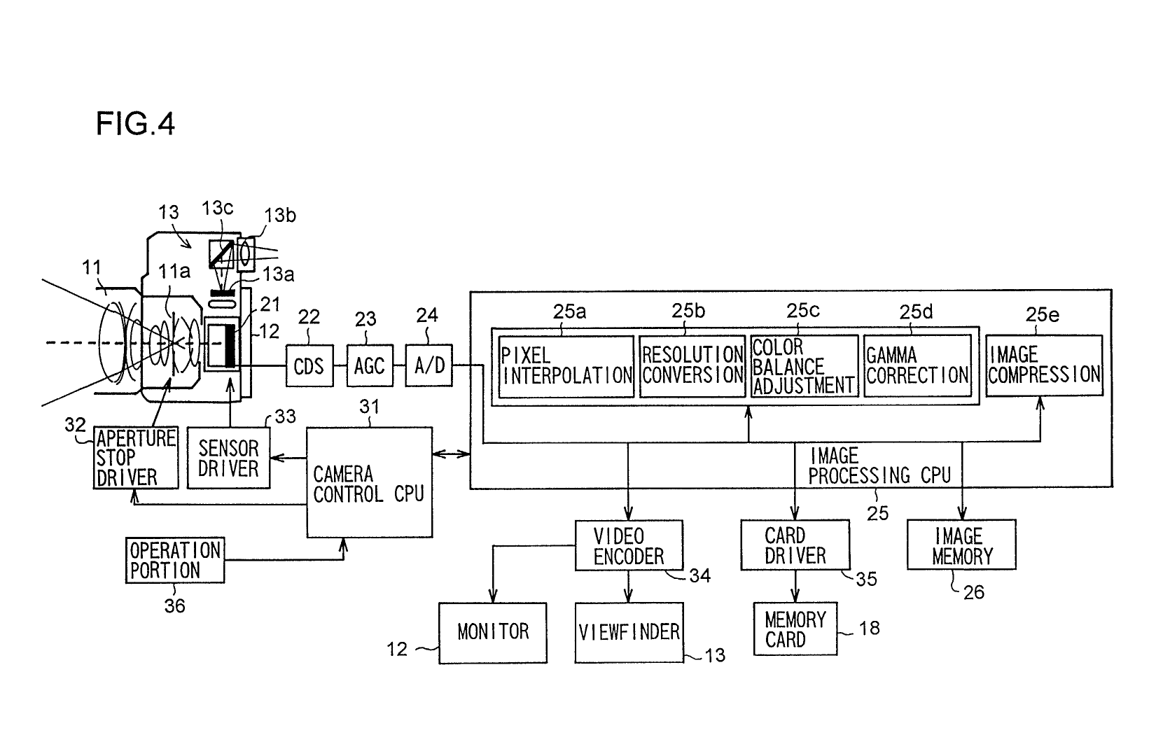

Hereinafter, a digital camera embodying the present invention will be described with reference to the drawings. FIGS. 1 to 3 show the external appearance of the digital camera 1 of this embodiment, and FIG. 4 schematically shows the circuit configuration thereof FIGS. 1, 2, and 3 are a front view, a back view, and a top view, respectively, of the digital camera 1.

The digital camera 1 has a taking lens 11 in the front face, and two displays 12 and 13 on the back face. In the top face of the digital camera 1 are arranged a push-type shutter start button 14, a push-type switch 15, and a slide-type switch 16, and in the back face is arranged a slide-type switch 17. In the bottom face of the digital camera 1 is provided a slit (not shown) for inserting a memory card 18 (see FIG. 4) serving as a recording medium.

As shown in FIG. 4, the taking lens 11 is provided with an aperture stop 11a, and behind the taking lens 11 is provided an image sensor 21. The digital camera 1 picks up an image by converting the light received from a subject through the taking lens 11 into electric charges through photoelectric conversion by means of the image sensor 21, and produces image data representing the image by processing the electric charges accumulated in the image sensor by means of various circuits described later. The image represented by the thus produced image data is displayed on the displays 12 and 13, and, in response to an instruction to record that is produced when the shutter start button 14 is operated, the image data is recorded on the memory card 18. Image pick-up and image display are repeated at regular time intervals, for example every 1/30 second.

The display 12 is composed of a large liquid crystal display (LCD), and displays an image covering the same angle of view as an image represented by image data for recording. The user can observe the image displayed on the display 12 several tens of centimeters or more apart therefrom. Hereinafter, the display 12 will also be referred to as the monitor.

The display 13 is composed of a small LCD 13a, a convex lens 13b, and a reflecting mirror 13c. The LCD 13a displays an image covering an angle of view equal to or smaller than that of an image represented by image data for recording. The user, by looking at the LCD 13a through the lens 13b and the mirror 13c several centimeters or less apart therefrom, can observe the image displayed thereon with further enlargement. Hereinafter, the display 13 will also be referred to as the electronic viewfinder, or the viewfinder.

Viewing the image displayed on the monitor 12 or on the electronic viewfinder 13, the user can set the composition of a picture and confirm the focus condition of the taking lens 11 with respect to the subject. Whether to display an image on the monitor 12 or on the viewfinder 13 can be switched, and this switching is achieved through the operation of the switch 17. The monitor 12 and the viewfinder 13 both have horizontally (laterally) 640×vertically (longitudinally) 480 pixels.

The image sensor 21 is an area sensor having horizontally 2,560× vertically 1,920 pixels. Each pixel is provided with a filter that selectively transmits red (R), green (G), or blue (B) light so that all the pixels are classified into three type of pixels, i.e. pixels for R-light, pixels for G-light, and pixels for B-light. These three types of pixels are arranged in a Bayer-type configuration (see FIG. 7).

Now, the circuit configuration of the digital camera 1 will be described with reference to FIG. 4. The digital camera 1 is provided with a correlative double sampling (CDS) circuit 22 and an automatic gain control (AGC) circuit 23 for processing the electric charges output as an analog signal from the image sensor 21, an A/D converter for converting the analog signal to a digital signal, an image processing CPU 25 for processing the digital signal to produce image data representing an image taken, and an image memory 26 used for temporary storage by the image processing CPU 25.

The CDS circuit 22 reduces the noise contained in the analog signal output from the image sensor 21. The AGC circuit 23 adjusts the levels of all the signals from the CDS circuit 22 according to the gain of the AGC circuit 23 itself. The A/D converter 24 converts the analog signal from the AGC circuit 23 into a 10-bit digital signal.

The image processing CPU 25 subjects the thus digitized signal to pixel interpolation 25a, resolution conversion 25b, color balance adjustment 25c, and gamma correction 25d to produce image data representing an image taken. In addition, the image processing CPU 25 also performs image compression 25e on image data to be recorded on the memory card 18. The image processing CPU 25 first writes the digital signal from the A/D converter 24 to the image memory 26, and then, while reading and writing the signal from and to the image memory 26, proceeds with the aforementioned processing, starting with pixel interpolation 25a and ending with image compression 25e.

Through the pixel interpolation 25a, the signals missing at each pixel of the image sensor 21 (for example, the R and B signals at a G-light pixel) are produced from the signals of the surrounding pixels. This yields three, i.e. R, G, and B, signals for each pixel. For the G signal, the average of the middle two values among the signals of four pixels is calculated, and, for the R and B signals, the average of the signals of two pixels is calculated.

Through the resolution conversion 25b, a predetermined number of signals are extracted, in the horizontal and vertical directions individually, from the signals that have undergone the pixel interpolation. The signals are extracted in a manner that suits the use of the image data composed of the thus extracted signals. For example, it is possible to extract signals that are consecutive within a predetermined region, or extract signals that are predetermined intervals apart from one another over the entire region, i.e. in a curtailed manner. This determines the region of the image that the image data represents. The resolution conversion 25b also handles the copying of signal sequences in the horizontal and vertical directions. The copying of signal sequences is used to convert the resolution of the mage that is displayed in the enlarged display mode described later.

Through the color balance adjustment 25c, the intensity of the R, G, and B signal groups is adjusted individually so as to achieve a proper white balance. Specifically, on the basis of the intensity and distribution of the R, G, and B signals, a portion that is supposed to be white is located, and, within that portion, the averages of the R, G, and B signals are calculated individually. Then, on the basis of the intensity ratios of G/R and G/B, the intensity of the R, G, and B signals is corrected individually.

Through the gamma correction 25d, the signals have their intensity converted in a non-linear basis so as to suit the monitor 12, the viewfinder 13, or an external device that uses the image data by way of the memory card 18. Through the image compression 25e, the image data is compressed by being subjected to discrete cosine transform (DCT) and Huffman encoding conforming to the JPEG standards. It is possible to read the image data recorded on the memory card 18 and display an image on the monitor 12. In that case, the image processing CPU 25 reproduces decompressed image data by subjecting the image data read out to decompressing.

The digital camera 1 is further provided with a camera control CPU 31, an aperture stop driver 32, a sensor driver 33, a video encoder 34, and a card driver 35. The camera control CPU 31 controls the entire digital camera 1. The camera control CPU 31 is connected to an operation portion 36 including the aforementioned switches such as the shutter start button 14, and controls the operation of the digital camera 1 according to the signals fed thereto from the operation portion 36. The aperture stop driver 32 controls the aperture stop 11a. The sensor driver 33 produces control signals representing the timing with which to output the electric charges accumulated through photoelectric conversion, and feeds these control signals to the image sensor 21.

Unless an instruction to record is produced by the shutter start button 14, the aperture stop 11a is left fully open, and exposure is controlled by adjusting the photoelectric conversion time (i.e. the electronic shutter speed) of the image sensor 21. When an instruction to record is produced, i.e. when an image for recording is taken, exposure is controlled by setting the aperture of the aperture stop 11a and the photoelectric conversion time according to the relationship determined beforehand. Here, exposure is controlled on the basis of the intensity of the signals obtained from a predetermined area in the center of the image sensor 21.

The video encoder 34 encodes the image data fed from the image processing CPU 25 in conformity with the NTSC or PAL system, and then outputs the thus encoded image data to the monitor 12 and the viewfinder 13. The card driver 35 writes the image data fed from the image processing CPU 25 to the memory card 18, and feeds the image data read from the memory card 18 to the image processing CPU 25.

With respect to the recording of image data, the digital camera 1 operates either in a whole-frame recording mode or in a partial recording mode. The whole-frame recording mode is for producing image data representing an image covering a large angle of view corresponding to the entire image sensor 21, and the partial recording mode is for producing image data representing an image covering a small angle of view corresponding to part of the image sensor 21. The partial recording mode offers a digital telephoto function.

The angle of view in the partial recording mode can be selected from three choices, specifically 2/3, 1/2, and ¼ of the angle of view in the whole-frame recording mode. In other words, the magnification in the partial recording mode is 1.5×, 2×, or 4× (in terms of area, 2.25×, 4×, or 16×). The switching of the angle of view is achieved through the operation of the switch 15. Every time the switch 15 is operated, the angle of view switches from one choice to the next, with the magnification corresponding to the selected angle of view displayed on the monitor 12 or the viewfinder 13 for a while.

On the other hand, with respect to the displaying of an image, the digital camera 1 operates either in a unity-magnification display mode or in an enlarged display mode. The unity-magnification display mode is for displaying an image covering the same angle of view as an image for recording on the entire monitor 12 or on the entire viewfinder 13, and the enlarged display mode is for displaying an image covering a smaller angle of view than an image for recording on the entire viewfinder 13. The enlarged display mode offers a magnifier function. The switching between the unity-magnification display mode and the enlarged display mode is achieved through the operation of the switch 17.

The angle of view in the enlarged display mode can be selected from two choices, specifically ½ and ¼ of the angle of view in the unity-magnification display mode. In other words, the magnification in the enlarged display mode is 2× or 4× (in terms of area, 4× or 16×). The switching of the angle of view is achieved through the operation of the switch 16.

The whole-frame and partial recording modes can be freely combined with the unity-magnification and enlarged display modes. Thus, the user can select freely from four possible combinations. In the enlarged display mode, irrespective of whether the recording mode is the whole-frame or partial recording mode, a central region of an image that corresponds to ½ or ¼ of the angle of view of image data for recording is displayed. That is, in the enlarged display mode, the magnification is set not on the basis of the physical size of the image sensor 21, but on the size of an actual image.

However, when the partial recording mode at a magnification of 4× is combined with the enlarged display mode at a magnification of 4×, the total magnification with respect to the image sensor 21 is 16×, which results in displaying too small a region and is thus inappropriate for the confirmation of the focus condition. Specifically, the user cannot see what portion of the subject is being displayed, and the boundaries between the individual pixels of the image sensor 21 appears conspicuously. For this reason, in the digital camera 1, when the partial recording mode at a magnification of 4× is used in combination, the angle of view in the enlarged display mode is limited so as not to become less than 1/10 of the angle of view in the whole-frame recording mode. In this case, the magnification in the enlarged display mode is 2.5×.

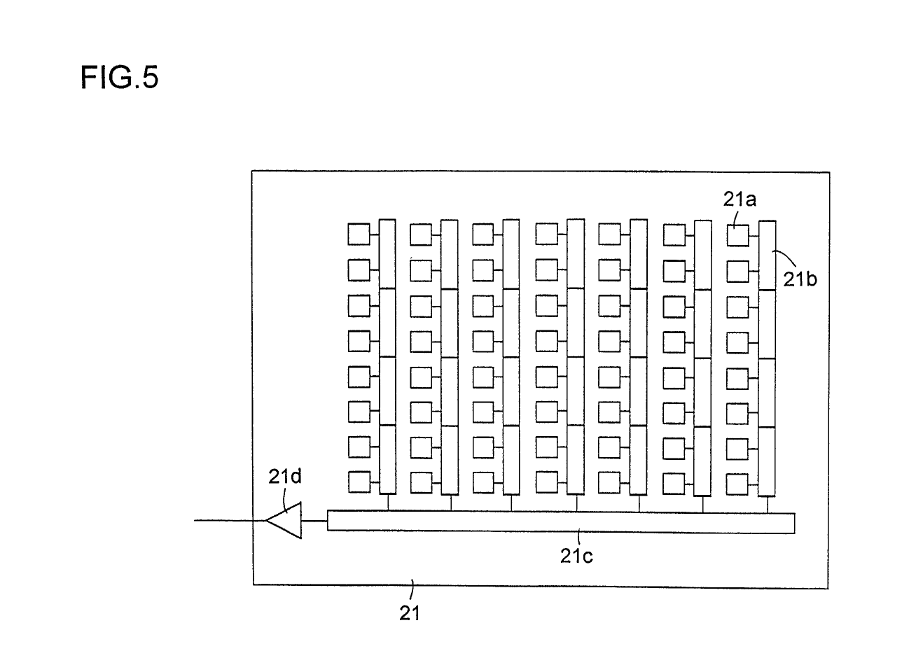

FIG. 5 schematically shows the configuration of the image sensor 21. The image sensor 21 has photodiodes 21a as pixels. As described previously, the image sensor 21 has horizontally 2,560× vertically 1,920 photodiodes 21a. The photodiodes 21a are arranged in a plurality of vertical columns, and vertical transfer registers 21b formed as charge-coupled devices (CCD) are provided one for each column so that the individual photodiodes 21a feed the electric charges (signals) they have accumulated through photoelectric conversion to the corresponding portions of those vertical transfer registers 21b.

The vertical transfer registers 21b are all connected to a horizontal transfer register 21 c similarly formed as a CCD so that the signals output from the individual photodiodes 21a are fed sequentially to the corresponding portions of the horizontal transfer registers 21c. The horizontal transfer registers 21c is connected to an amplifier 21d so that the output of the horizontal transfer register 21c is amplified by the amplifier 21d and is fed to the CDS circuit 22, which exists out of the figure.

As described previously, the output of the signals from the photodiodes 21a to the vertical transfer registers 21b, the transfer of the signals within the vertical transfer registers 21b, and the transfer of the signals within the horizontal transfer register 21c are controlled by the control signals fed from the sensor driver 33. On the other hand, the camera control CPU 31 controls the sensor driver 33 so as to change the photodiodes 21a from which to output electric charges and vary the transfer rates of the vertical transfer registers 21b and of the horizontal transfer register 21c according to whether the digital camera is operating in the whole-frame or partial recording mode and whether the digital camera is operating in the unity-magnification or enlarged display mode.

Now, practical examples will be described of the signal processing through which the electric charges read out from the image sensor 21 are processed to record image data on the memory card 18 or to display an image on the monitor 12 or the viewfinder 13. In the descriptions of the individual examples, the following symbols are used: P1 represents the step of reading out electric charges from the image sensor 21, P2 represents the step of producing image data representing an image, and P3 represents the step of displaying an image on the monitor 12 or the viewfinder 13; S1 represents the electric charges accumulated in the image sensor 21, S2 represents the signals produced by digitizing the electric charges read out in step P1, and S3 represents the signals produced as image data representing an image in the step P2.

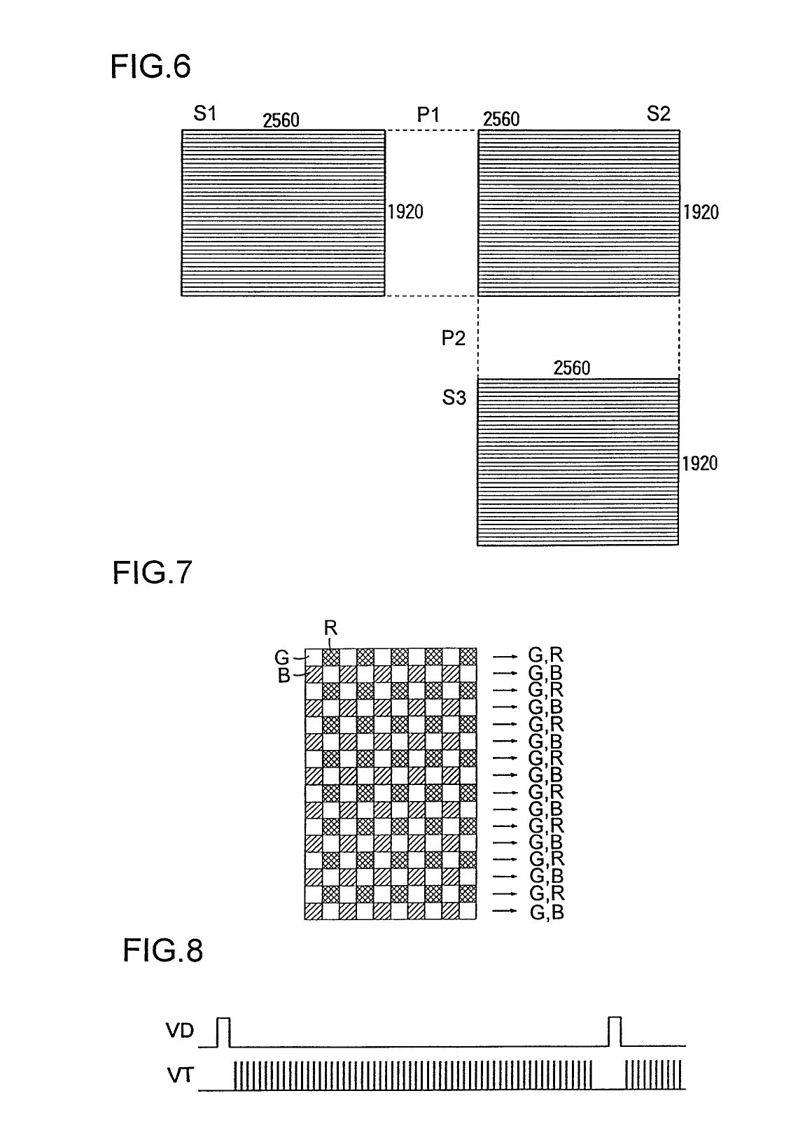

FIG. 6 shows a first example of signal processing. This example deals with the signal processing performed when an instruction to record is given in the whole-frame recording mode. In this example, electric charges are read out from all the rows of pixels that run in the horizontal direction of the image sensor 21, and all the signals S2 thus read out are used to produce signals S3 representing an image in the image data producing step P2. The signals S3 are recorded on the memory card 18. FIG. 7 shows the rows of pixels from which electric charges are read out in the read-out step P1.

FIG. 8 schematically shows the control signals that are fed from the sensor driver 33 to the image sensor 21 in the read-out step P1. Pulses VD request the photodiodes 21a to output electric charges, and are fed to all the photodiodes 21a. Pulses VT request the vertical transfer registers 21b to transfer signals. The transfer request pulses VT are produced at regular intervals throughout the periods in which they are produced.

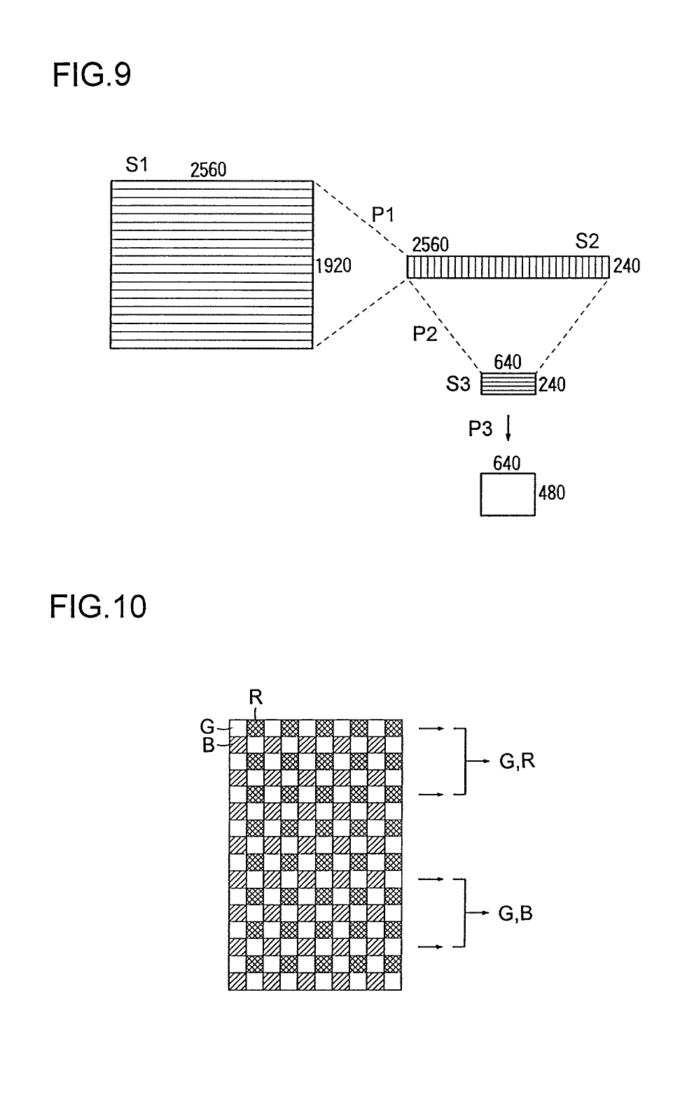

FIG. 9 shows a second example of signal processing. This example deals with the signal processing performed unless an instruction to record is given in the whole-frame recording mode combined with the unity-magnification display mode. In this example, electric charges are read out from every fourth row of pixels that runs in the horizontal direction of the image sensor 21, i.e. in a curtailed manner in the vertical direction. Moreover, in the read-out step, the electric charges of adjacent pixels of an identical color on the vertical transfer registers 21b are added together

FIG. 10 shows the rows of pixels from which electric charges are read out. Electric charges are read out from four out of sixteen rows of pixels, specifically two rows of pixels including G- and R-light pixels and two rows of pixels including G- and B-light pixels. The electric charges of the two R-light pixels are added together, the electric charges of the two B-light pixels are added together, and the electric charges of the four G-light pixels are added together two by two. Eventually, the signals S2 read out contain 240 rows of pixels that run in the horizontal direction. The read-out step P1 here can be performed eight times as quickly as the read-out step P1 in the first example.

In the image data producing step P2, within each of the rows of signals that run in the horizontal direction, signals are extracted for every fourth pixel so that the signals S3 contain horizontally 640× vertically 240 signals. Here, the number of signals in the horizontal direction is equal to the number of pixels of the LCDs of the monitor 12 and the viewfinder 13 in the horizontal direction, and the number of signals in the vertical direction is half the number of pixels of the LCDs in the vertical direction. Accordingly, in the display step P3, each of the rows of signals that run in the horizontal direction is output twice. This causes an image covering an angle of view corresponding to the entire image sensor 21 to be displayed on the entire monitor 12 and on the entire viewfinder 13.

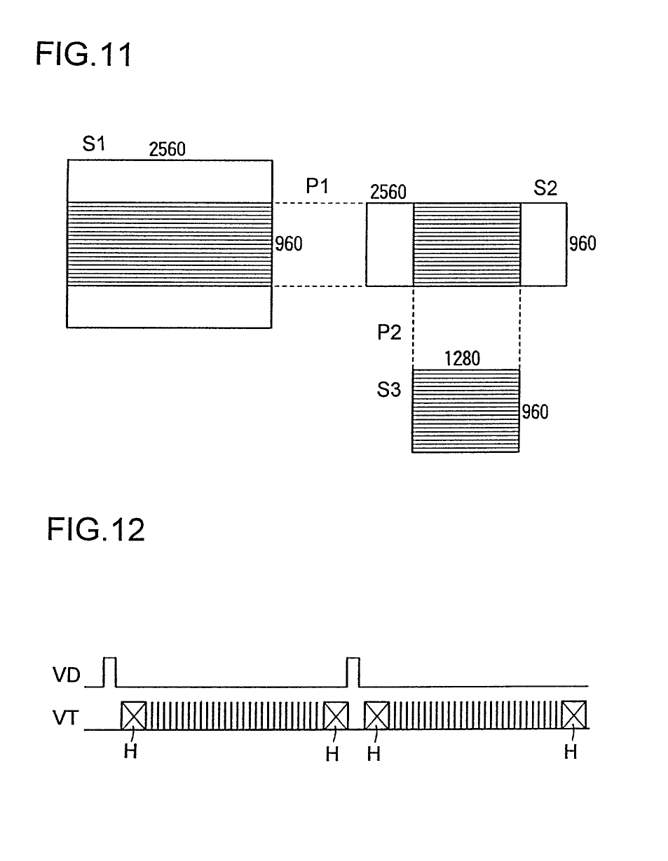

FIG. 11 shows a third example of signal processing. This example deals with the signal processing performed when an instruction to record is given in the partial recording mode at a magnification of 2×. In the read-out step P1, electric charges are read out from all the 960 rows of pixels located in a vertically central portion of the image sensor 21. In the image data producing step P2, within each of the rows of signals contained in the signals S2 thus read out, all the 1,280 signals located in a central portion thereof are extracted to produce signals S3 representing an image. The signals S3 are recorded on the memory card 18.

FIG. 12 schematically shows the control signals fed from the sensor driver 33 to the image sensor 21 in the read-out step P1. In FIG. 12, in periods marked H, the drive request pulses VT are produced at shorter intervals than in other periods to request driving at a higher rate. The output request pulses VD cause electric charges to be output from all the rows of pixels to the vertical transfer registers 21b. However, the vertical transfer registers 21b are driven at a higher rate in the periods marked H so that no electric charge is read out from the 480 rows of pixels at the top and the 480 rows of pixels at the bottom. On the other hand, in the other periods, the vertical transfer registers 21b are driven at a normal rate in synchronism with the horizontal transfer register 21c so that electric charges are read out from the 960 rows of pixels in the center. Thus, the read-out step here requires half the time required in the first example.

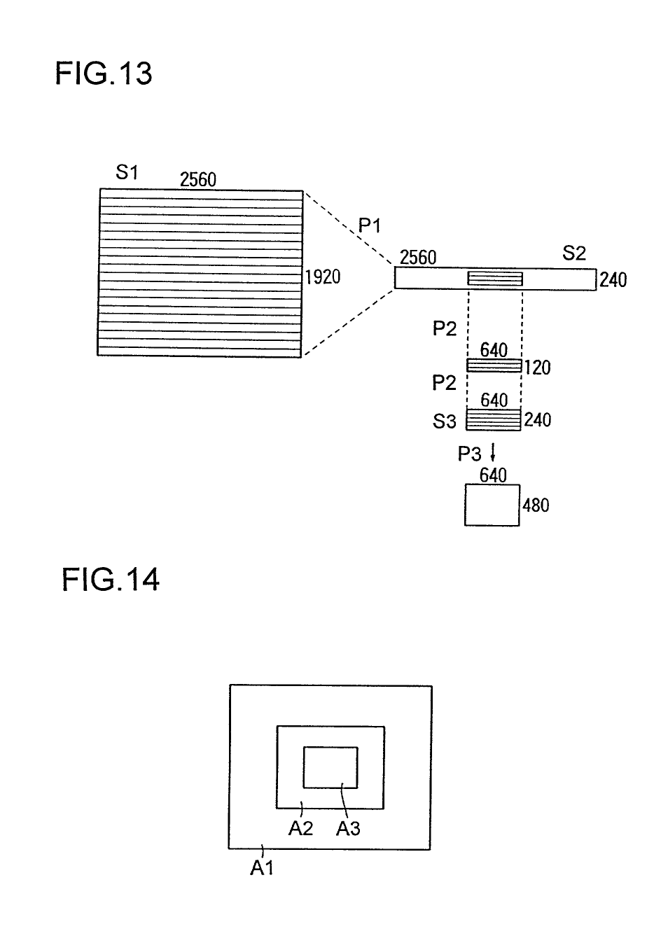

FIG. 13 shows a fourth example of signal processing. This example deals with the signal processing performed unless an instruction to record is given in the partial recording mode at a magnification of 2× combined with the enlarged display mode at a magnification of 2×. The read-out step P1 is performed in the same manner as in the second example. Specifically, electric charges are read out from every fourth row of pixels, and the electric charges of two pixels of an identical color are added together. In the image data producing step P2, from the signals S2 thus read out, the horizontally 640× vertically 120 signals in the center are extracted, and each of the rows of signals that run in the horizontal direction is duplicated by being copied to produce signals S3 representing an image. In the display step S3, each of the rows of signals contained in the signals S3 is output twice. FIG. 14 shows the relationship between the angle of view A1 of the image sensor 21, the angle of view A2 of an image for recording, and the angle of view A3 of an image for display.

In this example of signal processing, the read-out step P1 is performed in the same manner as in the whole-frame recording mode, and therefore there is no need to prepare separate control signals to be fed from the sensor driver 33 to the image sensor 21. This helps avoid complicating the configuration of the sensor driver 33 and the image sensor 21. Moreover, there is no need to vary sensitivity, and therefore it is easy to switch between the unity-magnification display mode and the enlarged display mode. The displayed image has only half the resolution of an image taken for recording in the vertical direction, but has the same resolution in the horizontal direction. This helps avoid unduly spoiling easy confirmation of the focus condition.

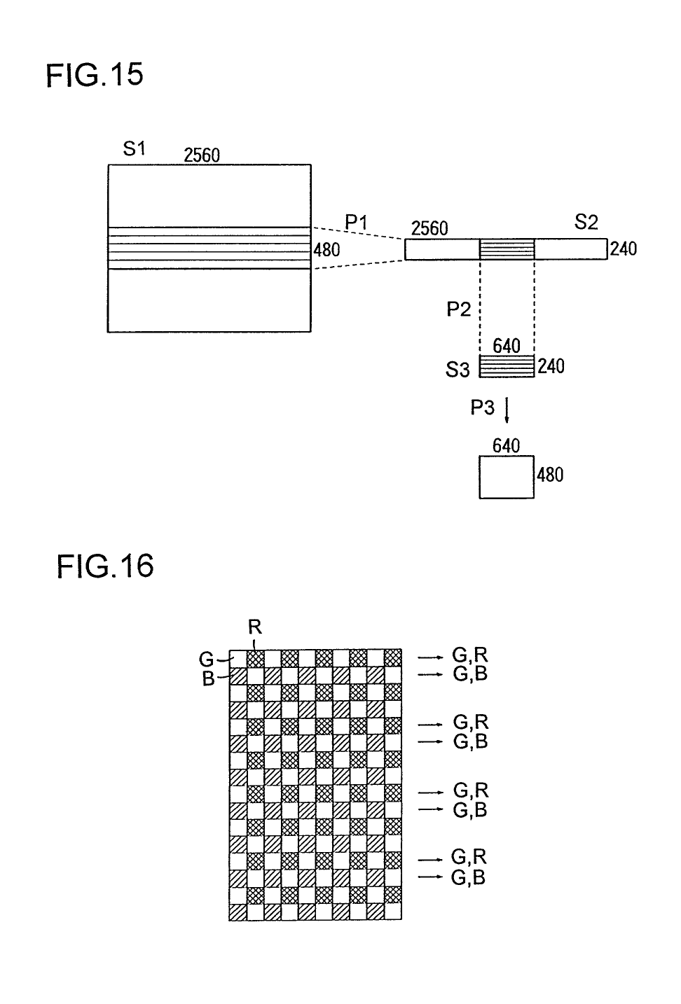

FIG. 15 shows a fifth example of signal processing. This example also deals with the signal processing performed unless an instruction to record is given in the partial recording mode at a magnification of 2× combined with the enlarged display mode at a magnification of 2×. In the read-out step P1, electric charges are read out from every second row of pixels within a vertically central portion of the image sensor 21, specifically from 240 rows of pixels in total. In the image data producing step P2, within each of the rows of signals contained in the signals S2, the 640 signals in the center are extracted to produce signals S3 representing an image. In the display step P3, each of the rows of signals contained in the signals S3 is output twice. FIG. 16 shows the rows of pixels from which electric charges are read out in the read-out step P1. The angle of view A1 of the image sensor 21, the angle of view A2 of an image for recording, and the angle of view A3 of an image for display have the same relationship as shown in FIG. 14.

The read-out step P1 is performed in the same manner as in the third example. Specifically, the electric charges obtained from the 720 rows of pixels at the top and the 720 rows of pixels at the bottom of the image sensor 21 are transferred at a higher rate, and only the electric charges obtained from the rows of pixels in the center are output at a normal rate to the horizontal transfer register. This makes it possible to perform the read-out step in a very short time.

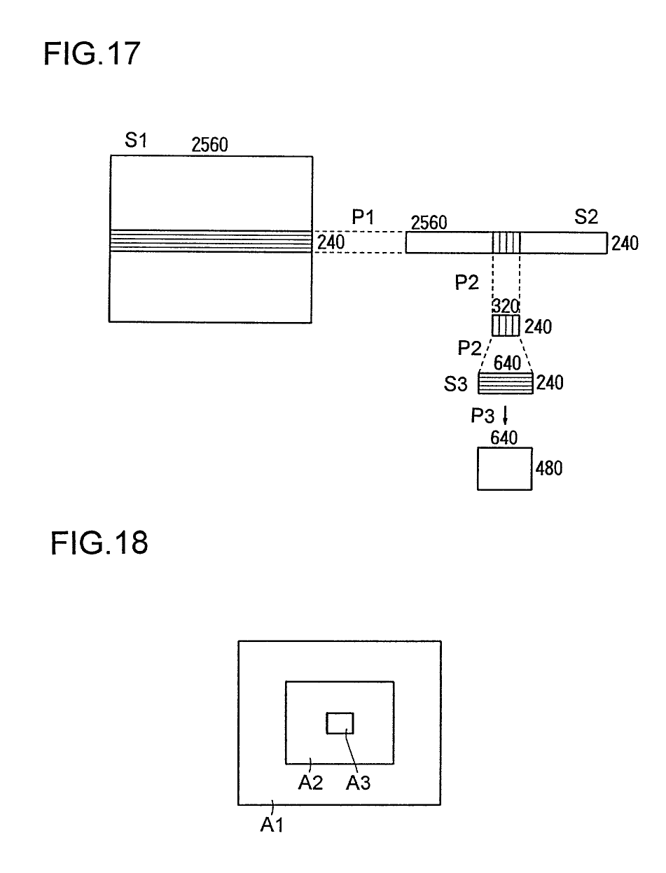

FIG. 17 shows a sixth example of signal processing. This example deals with the signal processing performed unless an instruction to record is given in the partial recording mode at a magnification of 2× combined with the enlarged display mode at a magnification of 4×. In the read-out step P1, electric charges are read out from all the 240 rows of pixels located in a vertically central portion of the image sensor 21. In the image data producing step P2, within each of the rows of signals contained in the signals S2, the 320 signals in the center are extracted, and each of the columns of pixels contained in the thus extracted signals that run in the vertical direction is copied to produce signals S3 representing an image. In the display step P3, each of the rows of pixels contained in the signals S3 that run in the horizontal direction is output twice. FIG. 18 shows the relationship between the angle of view A1 of the image sensor 21, the angle of view A2 of an image for recording, and the angle of view A3 of an image for display.

In the read-out step P1, the electric charges obtained from the 840 rows of pixels at the top and the 840 rows of pixels at the bottom of the image sensor 21 are transferred at a higher rate, and only the electric charges obtained from the rows of pixels in the center are output at a normal rate to the horizontal transfer register. Thus, the read-out step is complete in a very short time. Here, although the rows of pixels are copied in the vertical direction in the step P2, the displayed image has the same resolution as an image for recording. This helps maintain easy confirmation of the focus condition.

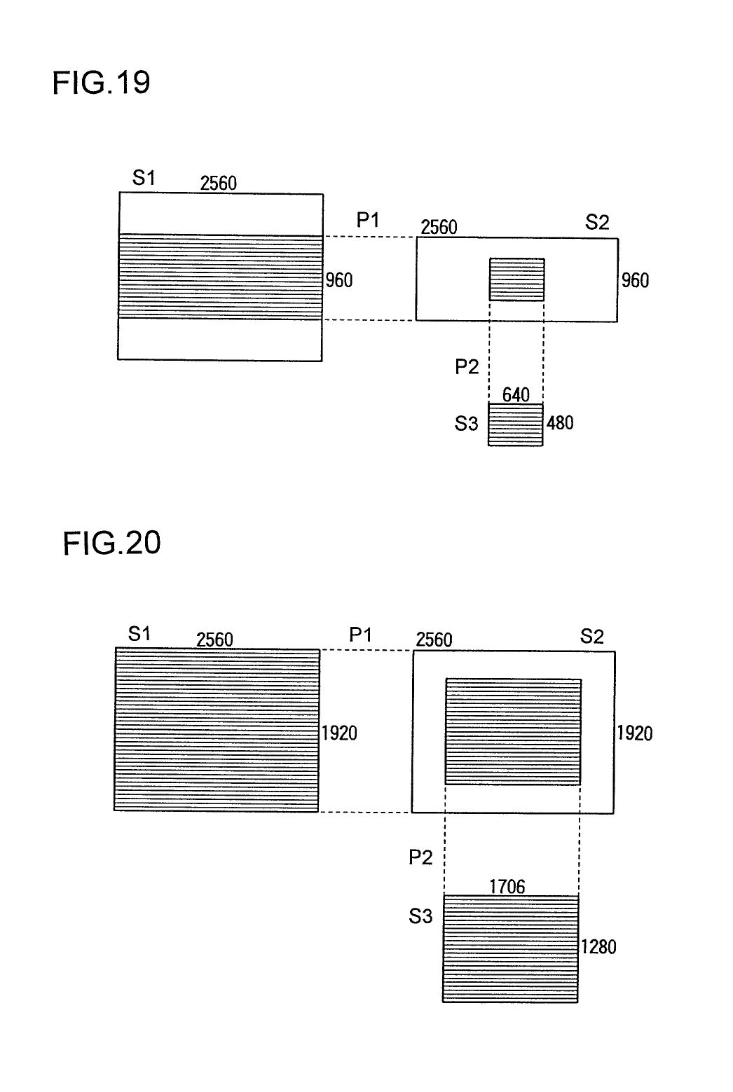

FIG. 19 shows a seventh example of signal processing. This example deals with the signal processing performed when an instruction to record is given in the partial recording mode at a magnification of 4×. In the read-out step P1, electric charges are read out from all the 960 rows of pixels in a vertically central portion of the image sensor 21. In the image data producing step P2, out of the signals S2, the horizontally 640× vertically 480 signals in the center are extracted to produce signals S3 representing an image. The signals S3 are recorded on the memory card 18.

In this example also, the electric charges obtained from the 480 rows of pixels at the top and the 480 rows of pixels at the bottom of the image sensor 21 are transferred at a higher rate, and only the electric charges obtained from the rows of pixels in the center are output at a normal rate to the horizontal transfer register. Thus, the read-out step P1 requires a very short time.

FIG. 20 shows an eighth example of signal processing. This example deals with the signal processing performed when an instruction to record is given in the partial recording mode at a magnification of 1.5×. In the read-out step P1, electric charges are read out from all the rows of pixels of the image sensor 21. In the image data producing step P2, out of the signals S2, the horizontally 1,706× vertically 1,280 signals in the center are extracted to produce signals S3 representing an image. The signals S3 are recorded on the memory card 18.

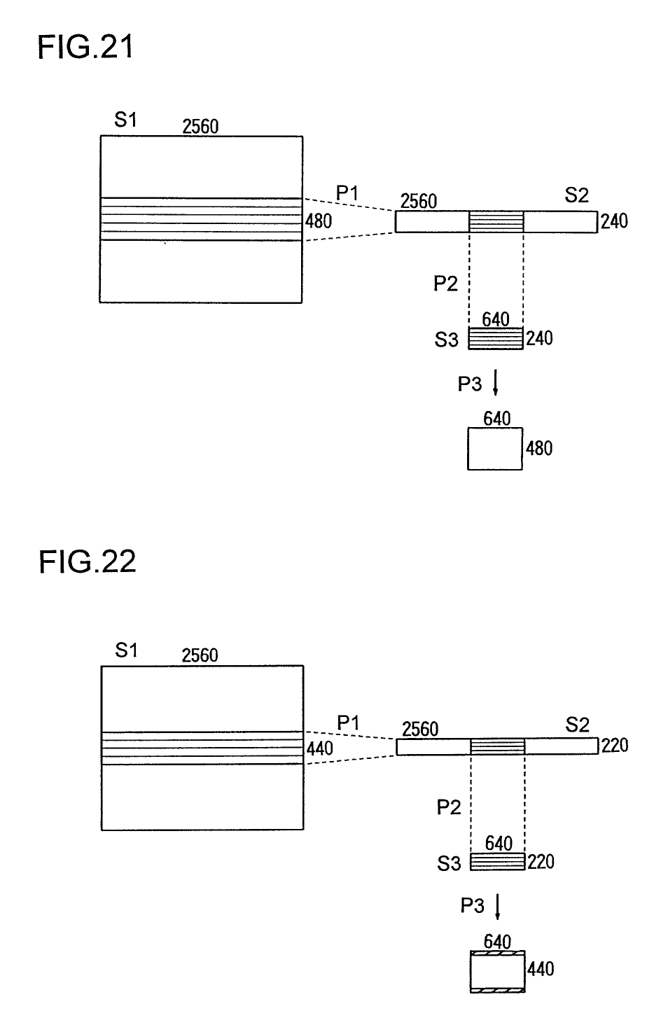

FIG. 21 shows a ninth example of signal processing. This example deals with the signal processing performed unless an instruction to record is given in the whole-frame recording mode combined with the enlarged display mode at a magnification of 4×. In the read-out step P1, electric charges are read out from every second row of pixels within a vertically central portion of the image sensor 21, specifically from 240 rows of pixels in total. In the image data producing step P2, within each of the rows of pixels contained in the signals S2, the 640 signals in the center are extracted to produce signals S3 representing an image. In the display step P3, each of the rows of pixels contained in the signals S3 is output twice. The rows of pixels from which electric charges are read out in the read-out step P1 are the same as shown in FIG. 16.

FIG. 22 shows a tenth example of signal processing. This example also deals with the signal processing performed unless an instruction to record is given in the whole-frame recording mode combined with the enlarged display mode at a magnification of 4×. Here, the magnification in the vertical direction is somewhat lower than 4×. In the read-out step P1, electric charges are read out from every second row of pixels within a vertically central portion of the image sensor 21, specifically from 220 rows of pixels in total. In the image data producing step P2, within each of the rows of pixels contained in the signals S2, the 640 signals in the center are extracted to produce signals S3 representing an image. In the display step P3, each of the rows of pixels contained in the signals S3 is output twice. The image displayed here is the same as the image displayed in the ninth example except that the former is about 4% smaller at the top and about 4% smaller at the bottom than the latter. The rows of pixels from which electric charges are read out in the read-out step P1 are the same as shown in FIG. 16.

The purpose of making the magnification in the vertical direction somewhat lower than 4× in this example is to make it possible to display an image in the enlarged display mode at speed equal to or higher than in the unity-magnification display mode. In the digital camera 1 of the embodiment under discussion, the image sensor 21 has vertically 1,920 pixels, which is not an especially high number, and therefore an image is displayed in the enlarged display mode at no lower speed than in the unity-magnification display mode even in the ninth example. However, in arrangements that employ as the image sensor 21 one having a very large number of pixels, the tenth example of signal processing is effective in increasing the display speed in the enlarged display mode.

The digital camera 1 of this embodiment is provided with, as a display, both a monitor 12 and a viewfinder 13. However, the viewfinder 13 may be omitted. In that case, the image displayed on the monitor 12 is switched according to whether the digital camera 1 is operating in the unity-magnification display mode or the enlarged display mode. It is to be understood that any number or value specifically given in the above descriptions with respect to the number of pixels, the number of signals to be processed, the magnification, and the like is merely an example, and therefore may be set in any other manner. Since image sensors developed in the future are expected to have increasing numbers of pixels, the number of signals to be processed and the magnification are best set according to the number of pixels that the actually used image sensor has.

Obviously, many modifications and variations of the present invention are possible in light of the above teachings. It is therefore to be understood that within the scope of the appended claims, the invention may be practiced other than as specifically described.

What is claimed is:

1. A digital camera comprising:
an image sensor having pixels arranged two-dimensionally;
a controller and/or circuit for reading out electric charges accumulated in the individual pixels of the image sensor from one row of pixels after another to produce image data of an image for display, and for producing image data of an image for recording on receiving an instruction to record; and
a selector for choosing between a whole-frame recording mode in which an angle of view of the image for recording is made equal to an angle of view corresponding to substantially the entire image sensor and a partial recording mode in which the angle of view of the image for recording is made equal to an angle of view corresponding to part of the image sensor,
wherein the controller and/or circuit produces the image data of the image for display by reading out the electric charges from only one row of pixels out of a plurality of consecutive rows of pixels over the entire image sensor, and, when the partial recording mode is chosen, produces the image data of the image for recording by reading out the electric charges from all rows of pixels located within a predetermined area on the image sensor.

2. A digital cameral as claimed in claim 1,
wherein the angle of view of the image for recording in the partial recording mode is variable, and
wherein when, in the partial recording mode, the angle of view of the image for recording is smaller than an angle of view corresponding to the predetermined area on the image sensor, the controller and/or circuit produces the image data of the image for recording by using only the electric charges read out from part of the rows of pixels located within the predetermined area on the image sensor.

3. A digital cameral as claimed in claim 1,
wherein the angle of view of the image for recording in the partial recording mode is variable, and
wherein when, in the partial recording mode, the angle of view of the image for recording is greater than an angle of view corresponding to the predetermined area on the image sensor, the controller and/or circuit produces the image data of the image for recording by reading out the electric charges from all the rows of pixels over the entire image sensor and using only the electric charges read out from part of those rows of pixels.

4. A digital camera comprising:
an image sensor having pixels arranged two-dimensionally;
a controller and/or circuit for reading out electric charges accumulated in the individual pixels of the image sensor from one row of pixels after another to produce image data of an image for display, and for producing image data of an image for recording on receiving an instruction to record;
a recording mode selector for choosing between a whole-frame recording mode in which an angle of view of the image for recording is made equal to an angle of view corresponding to substantially the entire image sensor and a partial recording mode in which the angle of view of the image for recording is made equal to an angle of view corresponding to part of the image sensor; and
a display mode selector for choosing between a unity-magnification display mode in which the angle of view of the image for display is made equal to the angle of view of the image for recording and the image for display is displayed in a predetermined region and an enlarged display mode in which the angle of view of the image for display is made smaller than the angle of view of the image for recording and the image for display is displayed in a region substantially identical with the predetermined region used in the unity-magnification display mode,
wherein the angle of view of the image for display in the enlarged display mode is set to be a predetermined angle relative to the angle of view of the image for recording both in the whole-frame recording mode and in the partial recording mode.

5. A digital camera as claimed in claim 4,
wherein the angle of view of the image for recording in the partial recording mode is variable, and
wherein the angle of view of the image for display in the partial recording mode is equal to or greater than a predetermined value set on a basis of size of the image sensor.

6. A digital camera comprising:
an image sensor having pixels arranged two-dimensionally;
a controller and/or circuit for reading out electric charges accumulated in the individual pixels of the image sensor from one row of pixels after another to produce image data of an image for display, and for producing image data of an image for recording on receiving an instruction to record;
a selector for choosing between a unity-magnification display mode in which an angle of view of the image for display is made equal to an angle of view of the image for recording and the image for display is displayed in a predetermined region and an enlarged display mode in which the angle of view of the image for display is made smaller than the angle of view of the image for recording and the image for display is displayed in a region substantially identical with the predetermined region used in the unity-magnification display mode,
wherein, in the unity-magnification display mode, the controller and/or circuit produces the image data of the image for display by reading out only the electric charges from one row of pixels out of a first predetermined number of consecutive rows of pixels over the entire image sensor, and, in the enlarged display mode, the controller and/or circuit produces the image data of the image for display by reading out only the electric charges from one row of pixels out of a second predetermined number, smaller than the first predetermined number, of consecutive rows of pixels within a predetermined area on the image sensor.

7. A digital camera as claimed in claim 6,
wherein the first predetermined number, the second predetermined number, and size of the predetermined area are so set that an image is displayed at substantially identical speed in the unity-magnification display mode and in the enlarged display mode.

8. A digital camera as claimed in claim 6,
wherein the first predetermined number, the second predetermined number, and size of the predetermined area are so set that an image actually displayed is of substantially identical size in the unity-magnification display mode and in the enlarged display mode.
